(19) United States
(12) Patent Application Publication
(10) Pub. No.: US 2014/0272357 A1
(43) Pub. Date: Sep. 18, 2014

(54) FILM MATERIALS COMPRISING BIODEGRADABLE AND/OR SUSTAINABLE POLYMERIC COMPONENTS

(71) Applicant: CLOPAY PLASTIC PRODUCTS COMPANY, INC., Mason, OH (US)

(72) Inventors: Frank He, Mason, OH (US); Linda Lin, Mason, OH (US); Leopoldo V. Cancio, Vero Beach, FL (US); Pai-Chuan Wu, Cincinnati, OH (US)

(73) Assignee: CLOPAY PLASTIC PRODUCTS COMPANY, INC., Mason, OH (US)

(21) Appl. No.: 13/796,528

(22) Filed: Mar. 12, 2013

(51) Int. Cl. C08L 67/04; B32B 37/06; B32B 38/00; B32B 37/24

(52) U.S. Cl. CPC C08L 67/04; B32B 37/24; B32B 37/06; B32B 38/0012
USPC 428/219; 525/190; 524/502; 521/134; 524/427; 156/60; 156/244.11; 156/73.4; 156/308.2; 156/229; 442/395

(57) ABSTRACT

Polymer films comprising blends of biodegradable and/or sustainable polymer are disclosed. These films significantly reduce the amount of petroleum-based polymer in the film, while providing cost savings, processing ease and properties desired by consumers. Polymer films comprising blends of biodegradable and/or sustainable polymers that are microporous and breathable are also disclosed. The polymer films of the present invention may also be laminated to other substrates, such as nonwoven fabrics.

### BACKGROUND OF THE INVENTION

Because of environmental concerns, there is growing interest in biodegradable and/or sustainable polymers in products. Consumers like the convenience of plastics, but worry about expanding landfills that contain materials that don't degrade. Petroleum resources are diminishing, and there is a growing desire to reduce human dependence on oil. For these reasons, polymers that are biodegradable, sustainable, or both are becoming more popular in consumer products.

Biodegradable polymers tend to be stiff and brittle in character. For many years, researchers have studied additives such as plasticizers and impact modifiers to make biodegradable polymers softer, less brittle, and easier to extrude or mold into useful products. Biodegradable polymers have also tended to be very expensive, although the growing demand for these materials is bringing down the price.

Sustainable polymers, which are made from renewable resources such as plants, may or may not be biodegradable. There has been much research to develop biodegradable polymers from renewable resources, of course. Another area of research has been to develop ways to use plant-based raw materials to synthesize the most common polymers made from petroleum, in particular polyethylene (PE). Replacing petroleum-based PE with plant-based PE would both reduce our dependence on oil and remove carbon dioxide from the air, thereby counteracting global warming.

As early as the 1980's, there was a great deal of research into manufacturing common plastic products, such as plastic films and packaging materials, where the polymeric component was entirely or predominantly made up of biodegradable polymers. This was because of the perceived need to provide materials that would degrade completely when they were discarded. Unfortunately, while this was a laudable goal, these totally-biodegradable materials have largely failed in the marketplace. This failure is due to a number of reasons. First, biodegradable polymers have traditionally been significantly more expensive than the non-biodegradable petroleum-based resins. Biodegradable materials dramatically increase the cost of products, particularly disposable products, and most consumers simply will not pay the extra expense. Biodegradable polymers are also sometimes more difficult to process than traditional polymers. Biodegradable polymers can be more sensitive to moisture and heat, and more apt to degrade when heated for extrusion or thermoforming processes. Therefore, they must be processed at lower temperatures under more controlled conditions. For these reasons, it is more expensive to manufacture products from these polymers. Also, biodegradable films, in particular, tend to slowly degrade during storage and therefore have a relatively short shelf-life. Finally, biodegradable polymers often lack desirable physical properties that consumers demand. These polymers tend to be stiff, brittle, and noisy, with an undesirably stiff ‘feel’ compared to traditional polyolefin, polyester or polyamide materials. For these and other reasons, biodegradable polymeric materials and particularly biodegradable films have not been a commercial success.

Despite these drawbacks, consumers today are once again interested in reducing the use of petroleum products and instead using biodegradable and sustainable materials. Consumers want products that use less oil-based material and yet still have the look, feel and performance of traditional polymers, and at no more than a modest price increase. Hence, there is a need for developing soft, quiet, flexible polymer materials, particularly polymeric films that contain biodegradable and/or sustainable components and thus reduce the use of oil-based polymeric resins.

### SUMMARY OF THE INVENTION

Some embodiments of the present invention relate to polymer films comprising one or more Bio-Sus polymers.

Other embodiments of the present invention relate to microporous polymer films comprising one or more Bio-Sus polymers.

Other embodiments of the present invention relate to methods of making films comprising one or more Bio-Sus polymers.

Other embodiments of the present invention relate to methods of making microporous-formable films comprising one or more Bio-Sus polymers, which are then activated to render the film microporous.

Other embodiments of the present invention relate to laminates comprising a web material, such as a nonwoven fabric, bonded to a film comprising one or more Bio-Sus polymers.

Other embodiments of the present invention relate to laminates comprising a web material, such as a nonwoven fabric, bonded to a microporous film comprising one or more Bio-Sus polymers.

Other embodiments of the present invention relate to methods of making laminates comprising a web material, such as a nonwoven fabric, bonded to a film comprising one or more Bio-Sus polymers.

Other embodiments of the present invention relate to methods of making laminates comprising a web material, such as a nonwoven fabric, bonded to a microporous film comprising one or more Bio-Sus polymers.

Other embodiments of the present invention relate to microporous laminates comprising web materials, such as nonwoven fabrics, bonded to microporous-formable films comprising one or more Bio-Sus polymers, which are then activated to render the laminates microporous.

Other embodiments of the present invention relate to methods of making microporous-formable laminates comprising web materials, such as nonwoven fabrics, bonded to microporous-formable films comprising one or more Bio-Sus polymers, which are then activated to render the laminates microporous.

### BRIEF DESCRIPTION OF THE DRAWING

The invention will be more fully understood in view of the drawings, in which:

FIG. 1 is a graph showing the tensile properties of materials of the present invention in the machine direction (MD);

FIG. 2 is a graph showing the tensile properties of materials of the present invention in the cross direction (CD).

### DETAILED DESCRIPTION

For the purpose of this disclosure, the following terms are defined:

“Biodegradable” refers to materials that degrade by biological processes resulting from the action of naturally-occurring micro-organisms such as bacteria, fungi and algae.

“Sustainable” refers to useful materials that can be economically produced from renewable resources such as plants.

“Bio-Sus” refers to polymers that are biodegradable, sustainable, or both.

“Standard polymers” or “standard film-forming polymers” refers to petroleum-based thermoplastic polymers that are used to manufacture polymer films. Examples of standard polymers include linear-low density polyethylene (LLDPE), low-density polyethylene (LDPE), polypropylene (PP), polyethylene terephthalate ester (PET), polyamides such as Nylon 6,6, and other similar polymeric materials.

“Filler” refers to an inexpensive material, often finely-powdered particles of organic or inorganic material, that is blended into a polymeric material for any of a variety of reasons. Fillers may be used to reduce the overall cost of the polymeric material. Fillers may also be functional. For instance, the fillers in microporous-formable films are present to form micropores in the film when the polymeric matrix is stretched and pulls away from the filler particles.

“Film” refers to material in a sheet-like form where the dimensions of the material in the x (length) and y (width) directions are substantially larger than the dimension in the z (thickness) direction.

“Basis weight” is an industry standard term that quantifies the thickness or unit mass of a film or laminate product. The basis weight is the mass per planar area of the sheet-like material. Basis weight is commonly stated in units of grams per square meter (gsm) or ounces per square yard (osy).

“Coextrusion” refers to a process of making multilayer polymer films. When a multilayer polymer film is made by a coextrusion process, each polymer or polymer blend comprising a layer of the film is melted by itself. The molten polymers may be layered inside the extrusion die, and the layers of molten polymer films are extruded from the die essentially simultaneously. In coextruded polymer films, the individual layers of the film are bonded together but remain essentially unmixed and distinct as layers within the film. This is contrasted with blended multicomponent films, where the polymer components are mixed to make an essentially homogeneous blend or heterogeneous mixture of polymers that are extruded in a single layer.

“Microporous” refers to a porous material in which the pores are not readily visible to the naked eye. Said pores typically have a maximum pore size not greater than about several microns.

“Microporous film” refers to a polymer film layer which comprises one or more filler materials and is stretched or activated after film formation to provide the microporosity therein. The micropores form tortuous paths through the depth of the film, which allow gases such as air and water vapor to pass readily through the film, but prevent liquids from passing through the film. Microporous films are thus distinctly different from apertured or needle-punched films, where apertures or holes (no matter the size of the holes) form a direct path through the depth of the film.

“Microporous-formable” refers to a material, typically a filled polymer film, that can be rendered microporous after being activated.

“Breathable” refers to a material, typically a film, with a water vapor transmission rate (WVTR) of 500 g/m²/24 hr or greater.

“Activation” or “activating” refers to a process by which a film is stretched. For microporous films or materials, activation causes micropores to form in the material by causing the surrounding polymeric film to separate from the filler particles, thereby creating tiny open areas or micropores around each particle. Said micropores, if they occur at a high concentration, create a continuous tortuous path through the film through which gas molecules such as water vapor and air can travel. A film or laminate that has undergone activation is called “activated.”

“Tensile properties” are properties measured when a material is subjected to stretching forces, and also the properties measured when the stretching forces are removed. Example tensile properties include but are not limited to tensile strength at break, percent elongation to break, modulus of elasticity, toughness or tensile energy to break, permanent set, tensile load at specified elongations, etc. Tensile properties of polymer films can be determined by standard test methods such as ASTM D882, “Standard Test Method For Tensile Properties of Thin Plastic Sheeting.”

The film of the present invention comprises a Bio-Sus polymeric material. Examples of biodegradable polymers include polylactic acid (PLA), polycaprolactone (PCL), polyhydroxy alkanoates (PHAs), polyhydroxybutyrates (PHBs), polyhydroxyvalerates (PHVs), thermoplastic starch (TPS) or aliphatic and aliphatic-aromatic polyesters. Biodegradable polymers are available from a variety of suppliers. For instance, PLA is sold under the trade name INGEO® by NatureWorks LLC, Minnetonka, Minn.; PCL is sold under the trade name CAPA® by Perstorp, Toledo, Ohio; TPS is sold under the trade name Terraloy™ by Teknor Apex, Pawtucket, R.I.; and biodegradable aliphatic-aromatic polyesters are sold under the trade name Hytrel® by DuPont, Wilmington, Del., or under the trade name Ecoflex® by BASF, Florham Park, N.J. Examples of sustainable polymers include polyolefins and polyesters made from plant- or bacteria-based sources. Sustainable polyethylene can be purchased from Braskem, São Paulo, Brazil; sustainable TPS masterbatch materials can be purchased under the trade name Cereplast Sustainables® or Cereplast Compostables® from Cereplast Inc., Segunda, Calif.; and sustainable polyesters are sold under the trade name Nodax™ by Meredian Inc., Bainbridge, Ga., or under the trade name Mirel® by Metabolix, Lowell, Mass.

The inventors have found that Bio-Sus polymers can be blended with standard film-forming polymers, such as polyolefins, polyesters and polyamides, at Bio-Sus concentrations of from up to about 40%, such that the films made from the blend retain acceptable film properties. The polymer film blend may contain 10% up to about 35% Bio-Sus polymer, preferably up to about 33% Bio-Sus polymer, more preferably 15% up to about 30% Bio-Sus polymer, more preferably up to about 28% Bio-Sus polymer, more preferably up to about 25% Bio-Sus polymer. The resulting films are easy to extrude under standard extrusion conditions. The resulting films are soft, quiet, flexible films that are not brittle.

Standard film-forming polymers in the inventive film comprise thermoplastic polymers that are processable into a film and stretchable to form micropores therein. Suitable polymers for the films include, but are not limited to, polyolefins, for example, polyethylene homopolymers and copolymers, and polypropylene homopolymers and copolymers, functionalized polyolefins, polyesters, poly(ester-ether), polyamides, including nylons, poly(ether-amide), polyether sulfones, fluoropolymers, polyurethanes and the like. Polyethylene homopolymers include those of low, medium or high density and/or those formed by high pressure or low pressure polymerization. Polyethylene and polypropylene copolymers include, but are not limited to, copolymers with C4-C8 alpha-olefin monomers, including 1-octene, 1-butene, 1-hexene and 4-methyl pentene. The polyethylene may be substantially linear or branched, and may be formed by various processes known in the art using catalysts such as Ziegler-Natta catalysts, metallocene or single-site catalysts or others widely known in the art. Examples of suitable copolymers include, but are not limited to, copolymers such as poly(ethylene-butene), poly(ethylene-hexene), poly(ethylene-octene), and poly(ethylene-propylene), poly(ethylene-vinylacetate), poly(ethylene-methylacrylate), poly(ethylene-acrylic acid), poly(ethylene-butylacrylate), poly(ethylene-propylenediene), and/or polyolefin terpolymers thereof. These are all formed from petroleum based sources.

It is also possible to use sustainable polyolefins in place of the standard film-forming polymer. Sustainable polyethylene, polypropylene, or other polyolefin generated from plant-based materials or other sustainable sources are suitable for the present invention. For instance, sustainable polyethylene can be purchased from Braskem, São Paulo, Brazil. Other sustainable polyolefins are in development by Braskem and other manufacturers.

The inventors have also discovered that it is possible to make the film of the present invention microporous and breathable by including one or more filler materials in the film composition. Suitable fillers for use in the film include, but are not limited to, various inorganic and organic materials, including, but not limited to, metal oxides, metal hydroxides, metal carbonates, organic polymers, derivatives thereof, and the like. Preferred fillers include, but are not limited to, calcium carbonate, diatomaceous earth, titanium dioxide, and mixtures thereof. These fillers must be included in the film formulation at concentrations sufficient to create micropores that can connect to form a tortuous path through the thickness of the film. For films intended to be microporous, the total amount of filler should comprise about 25-75% (by weight) of the film composition, more preferably about 25-70%, more preferably about 25-65%, more preferably about 30-60%, more preferably about 30-55%, more preferably about 30-50% of the film composition.

Calcium carbonate is a particularly preferred filler. Calcium carbonate has traditionally been mined from deposits on the earth. Calcium carbonate particles can also be prepared as a precipitate from certain chemical reactions. However, there is growing interest in sustainable sources of calcium carbonate. Calcium carbonate from plankton or algae sources can be harvested from the ocean bed. Such sustainable calcium carbonate is marketed, for instance, under the trade name Oshenite® by US Aragonite, Salem, Mass. Other potential sources of sustainable calcium carbonate or other mineral fillers include shells from aquatic creatures such as oysters, clams, snails, and scallops.

The fillers can be provided with different surface coatings. Suitable filler coatings are known in the art and include, but are not limited to, silicone glycol copolymers, ethylene glycol oligomers, acrylic acid, hydrogen-bonded complexes, carboxylated alcohols, ethoxylates, various ethoxylated alcohols, ethoxylated alkyl phenols, ethoxylated fatty esters, carboxylic acids or salts thereof, for example, stearic acid or behenic acid, esters, fluorinated coatings, or the like, as well as combinations thereof.

It may be necessary to include a compatibilizer in the film of the present invention, to improve the blending of the film-forming polymer with the Bio-Sus polymer. Typical compatibilizers include, but are not limited to, polymeric compounds such as polyesters, poly(alkyl methacrylates), poly(alkyl acrylates), polyvinyl acetate, polystyrene, and copolymers or blends of these. A preferred compatibilizer is poly(ethyl methyl acrylate) (EMA). The compatibilizer can be added to the blend at concentrations from 0-20%, more preferably from 5-10%, more preferably from 5-15%, more preferably from 8-15%, more preferably from 10-15%.

The film of the present invention may include other components to modify the film properties, aid in the processing of the film, or modify the appearance of the film. For example, viscosity-reducing polymers and plasticizers may be added as processing aids. Other additives such as pigments, dyes, antioxidants, antistatic agents, slip agents, foaming agents, and heat and/or light stabilizers. The polymer blends of the present invention can be formed by standard methods. Preferably they are simply meltblended.

Any film-forming process can prepare the film. Preferably, an extrusion process, such as cast extrusion or blown-film extrusion forms the film. Such processes are well known. The base weight of the film will generally be from 5-150 gsm, preferably 10-40 gsm. The film may also be in the form of a multilayer film. The multilayer film may be an AB, ABA, ABC, ABCBA, or any other such combination of multiple layers. Each layer of a multilayer film may comprise the same or different polymers. Coextrusion of multilayer films by cast or blown processes are also well known. The film may be melt-embossed during extrusion by being cast onto a roll engraved with an embossing pattern. The film may also be embossed at a later point in the film-forming process by being heated to soften the film, which is then pressed onto a roll engraved with an embossing pattern.

The films described herein can also be used to form a laminate. Such a laminate includes one or more substrate layers and the inventive film (e.g., monolayer or multilayer film). The substrate layer may be an extensible material including but not limited to another polymer film, fabric, nonwoven fabric, woven fabric, knitted fabric, scrim, or netting. The film can be bonded to substrate layers on one or both sides.

When two or more substrate layers are used to make the laminate, the substrate layers can be the same or different extensible materials. The composition of the substrate layers can be the same or different, even when the same extensible material is used (e.g., two nonwoven layers where one nonwoven layer is made from polyolefin and the other nonwoven layer is made from polyester).

The substrate layer (e.g., nonwoven fabrics) can have a basis weight of about 3 gsm to about 200 gsm, preferably about 3 gsm to about 75 gsm, more preferably about 5 gsm to about 50 gsm. If two substrate layers are used, one layer can have a basis weight that is the same or different from the other.

In some embodiments, the substrate layer is a nonwoven fabric. For example, the substrate layer can be spunbond nonwoven webs, carded nonwoven webs (e.g., thermally bonded, adhesively bonded, or spunlaced), meltblown nonwoven webs, spunlaced nonwoven webs, spunbond meltblown spunbond nonwoven webs, spunbond meltblown meltblown spunbond nonwoven webs, unbonded nonwoven webs, electrospun nonwoven webs, flashspun nonwoven webs (TYVEK™ by DuPont), or combinations thereof. These fabrics can comprise fibers of polyolefins such as polypropylene or polyethylene, polyesters, polyamides, polyurethanes, elastomers, rayon, cellulose, copolymers thereof, or blends thereof or mixtures thereof. The nonwoven fabrics can also comprise fibers that are homogenous structures or comprise bicomponent structures such as sheath/core, side-by-side, islands-in-the-sea, and other bicomponent configurations. For a detailed description of some nonwovens, see “Nonwoven Fabric Primer and Reference Sampler” by E. A. Vaughn, Association of the Nonwoven Fabrics Industry, 3d Edition (1992). Such nonwoven fabrics can have a basis weight of at least about 3 gsm, at least about 5 gsm, at least about 10 gsm, at least about 15 gsm, at least about 20 gsm, at least about 25 gsm, at least about 30 gsm, or at least about 35 gsm.

The nonwoven fabrics can include fibers or can be made from fibers that have a cross section perpendicular to the fiber longitudinal axis that is substantially non-circular. Substantially non-circular means that the ratio of the longest axis of the cross section to the shortest axis of the cross section is at least about 1.1. The shape of the cross section perpendicular to the fiber longitudinal axis of the substantially non-circular fibers can be rectangular (e.g., with rounded corners) which are also referred to as “flat” fibers, trilobal, or oblong (e.g., oval) in the cross section. These substantially non-circular fibers can provide more surface area to bond to the microporous film than nonwoven fabrics with fibers that are circular in cross section. Such an increase in surface area can increase the bond strength between the microporous film and fibers.

In order to render the inventive film or laminate microporous, the film or laminate with the appropriate filler is activated by stretching in order to create the micropores needed to make the film breathable. Machine-direction orientation (MDO) can be used to activate films or laminates in the machine direction, while tentering can activate films or laminates in the cross direction. Incremental stretching rolls can be used to activate films or laminates in the machine direction, cross direction, at a diagonal angle, or any combination thereof. In some embodiments, the depth of engagement used for incremental stretching is about 0.040 inches, about 0.060 inches, about 0.080 inches, about 0.100 inches, about 0.120 inches, about 0.150 inches, about 0.180 inches, about 0.200 inches, or about 0.250 inches.

Laminates of microporous films and nonwoven fabrics are particularly suited to activation by incremental stretching. As disclosed in the commonly-assigned U.S. Pat. No. 5,865,926 (“Wu '926”), which is incorporated by reference, laminates of the sort made here can be activated by incremental stretching using the intermeshing rollers described therein.

Alternatively, the filled precursor film may be stretched to render it microporous, then laminated to the nonwoven fabric. After the film is stretched by MDO, tentering, incremental stretching, or a combination thereof, the microporous film may be bonded to the nonwoven fabric. Bonding methods include, but are not limited to, adhesive bonding, thermal bonding, ultrasonic bonding, or calender bonding.

Additional processing steps such as annealing, aperturing, printing, slitting, laminating additional layers, and other such processes can be added to the manufacturing of the inventive film or laminate.

### Example 1

A film of the present invention was prepared by cast extrusion. The film comprised a linear low-density polyethylene (Dowlex™ 2045, Dow Chemical Company) at a concentration of 60% of the formulation weight, a Bio-Sus polymer of polylactic acid (PLA) (INGEO® 4043D, NatureWorks LLC) at a concentration of 25% of the formulation weight, and a compatibilizer of ethyl methyl acrylate (EMA) (OPTEMA™ TC110, ExxonMobil) at a concentration of 15% of the formulation weight. The film had a basis weight of roughly 40 gsm.

### Example 2

A film of the present invention was prepared by cast extrusion. The film comprised a linear low-density polyethylene (Dowlex™ 2045, Dow Chemical Company) at a concentration of 55% of the formulation weight, a Bio-Sus polymer of PLA (INGEO® 4043D, NatureWorks) at a concentration of 30% of the formulation weight, and a compatibilizer of EMA (OPTEMA™ TC110, ExxonMobil) at a concentration of 15% of the formulation weight. The film had a basis weight of roughly 40 gsm.

### Comparative Example A

A film of the present invention was prepared by cast extrusion. The film comprised a linear low-density polyethylene (Dowlex™ 2045, Dow Chemical Company) at a concentration of 50% of the formulation weight, a Bio-Sus polymer of PLA (INGEO® 4043D, NatureWorks) at a concentration of 35% of the formulation weight, and a compatibilizer of EMA (OPTEMA™ TC110, ExxonMobil) at a concentration of 15% of the formulation weight. The film had a basis weight of roughly 40 gsm.

### Comparative Example B

A film of the present invention was prepared by cast extrusion. The film comprised a linear low-density polyethylene (Dowlex™ 2045, Dow Chemical Company) at a concentration of 45% of the formulation weight, a Bio-Sus polymer of PLA (INGEO® 4043D, NatureWorks) at a concentration of 40% of the formulation weight, and a compatibilizer of EMA (OPTEMA™ TC110, ExxonMobil) at a concentration of 15% of the formulation weight. The film had a basis weight of roughly 40 gsm.

The films made in Examples 1 and 2 and Comparative Examples A and B were extruded easily into good quality films. The films were tested by tensile testing to determine their maximum strain at break. FIGS. 1 and 2 show the maximum strain of each example in the machine direction (MD) and cross-direction (CD), respectively. All of the samples had a strain at break between 450 and 550% in the MD. However, in the CD, the Examples show a dramatic difference over the Comparative Examples. Example 1 has a strain at break of about 175% in the CD. Example 2 has a strain at break of about 70% in the CD. Both Comparative Examples CD strains at break of less than about 25%. This data indicates that Bio-Sus polymers can be added to polyolefin-based polymers at concentrations of up to about 30%, and the resulting film is still tough enough to stretch reasonably well in the cross direction. This ability to stretch without breaking is important because stretching a film is one way to render it softer and less stiff. This ability to stretch without breaking is also important when activating film to render it microporous, particularly if the activation is performed in the CD.

### Example 3

A microporous film of the present invention was prepared by cast extrusion. The microporous film comprised a polyolefinic polymer (Vistamaxx® 6102, ExxonMobil) at a concentration of 25% of the formulation weight, a Bio-Sus polymer of polylactic acid (PLA) (INGEO® 4043D, NatureWorks LLC) at a concentration of 25% of the formulation weight, a compatibilizer of ethyl methyl acrylate (EMA) (OPTEMA™ TC120, ExxonMobil) at a concentration of 12.5% of the formulation weight, and calcium carbonate filler (SuperCoat®, Imerys) at a concentration of 37.5% of the formulation weight. The film had a basis weight of roughly 30 gsm after activation.

### Example 4

A microporous film of the present invention was prepared by cast extrusion. The microporous film comprised a polyolefinic polymer (Vistamaxx® 6102, ExxonMobil) at a concentration of 15% of the formulation weight, a Bio-Sus polymer of polylactic acid (PLA) (NGEO® 4043D, NatureWorks LLC) at a concentration of 25% of the formulation weight, a compatibilizer of ethyl methyl acrylate (EMA) (Optema™ TC120, ExxonMobil) at a concentration of 15% of the formulation weight, and calcium carbonate filler (SuperCoat®, Imerys, Atlanta, Ga.) at a concentration of 45% of the formulation weight. The film had a basis weight of roughly 30 gsm after activation.

Examples 3 and 4 were incrementally stretched in the CD and/or MD at various depths of engagement. The water vapor transmission rate (WVTR) of the stretched films and the corresponding unstretched precursor films were measured by the WVTR test described below. The results are shown in Table 1 below.

TABLE 1

| | VistaMaxx | PLA | EMA | | MD | CD | WVTR |
|---|---|---|---|---|---|---|---|
| Example | 6102 | 4043D | TC120 | CaCO₃ | Intermesh | Intermesh | (g/m²/24 hr) |
| 3 | 25% | 25% | 12.5% | 37.5% | precursor (no stretch) | | 74 |
| 3 | 25% | 25% | 12.5% | 37.5% | 0.080″ | 0.080″ | 1032 |
| 3 | 25% | 25% | 12.5% | 37.5% | 0.100″ | 0.100″ | 1548 |
| 4 | 15% | 25% | 15% | 45% | precursor (no stretch) | | 86 |
| 4 | 15% | 25% | 15% | 45% | 0.080″ | 0.080″ | 4735 |
| 4 | 15% | 25% | 15% | 45% | | 0.040″ | 840 |
| 4 | 15% | 25% | 15% | 45% | 0.040″ | 0.040″ | 1638 |

The unstretched precursor film of Example 3 had an unacceptably low value for the WVTR, while the stretched film had WVTR values in the about 1000-1500 range. These are acceptable levels of breathability for microporous films, particularly the higher value of about 1500. The unstretched precursor film of Example 4 also had an unacceptably low value for the WVTR, and the sample stretched only 0.040″ in the CD was breathable with a barely acceptable WVTR value of about 800. The Example 4 films stretched in both the MD and CD had acceptable WVTR values of about 1600 and, surprisingly, over about 4700 for the more deeply stretched film. The higher breathability seen in Example 4 is due in part to the higher concentration of filler. However, the blend of polyolefin and PLA also creates a tougher film that permits the film to be stretched more in the CD than would be possible in a film containing PLA as the sole or predominant polymeric ingredient.

### Example 5

A microporous film of the present invention was prepared by cast extrusion. The microporous film comprised two polyolefinic polymers: polypropylene (PRO-FAX® SG702, LyondellBasell) at a concentration of 25% and Vistamaxx® 6102 at a concentration of 10% of the formulation weight, a Bio-Sus polymer of polylactic acid (PLA) (INGEO® 4043D, NatureWorks LLC) at a concentration of 25% of the formulation weight, a compatibilizer of ethyl methyl acrylate (EMA) (Optema™ TC120, ExxonMobil) at a concentration of 10% of the formulation weight, and calcium carbonate filler (SuperCoat®, Imerys) at a concentration of 30% of the formulation weight. The film had a basis weight of roughly 30 gsm after activation.

Example 5 was incrementally stretched in the CD and/or MD at a depth of engagement of 0.040″. The water vapor transmission rate (WVTR) of the stretched films and the corresponding unstretched precursor films were measured by the WVTR test described below. The results are shown in Table 2 below.

TABLE 2

| | PP | VistaMaxx | PLA | EMA | | MD | CD | WVTR |
|---|---|---|---|---|---|---|---|---|
| Example | SG702 | 6102 | 4043D | TC120 | CaCO₃ | Intermesh | Intermesh | (g/m²/24 hr) |
| 5 | 25% | 10% | 25% | 10% | 30% | 0 | 0.040″ | 1066 |
| 5 | 25% | 10% | 25% | 10% | 30% | 0.040″ | 0.040″ | 1614 |

Example 5 shows acceptable levels of breathability, particularly when being stretched in the CD and MD both. This is particularly surprising, both because the depth of engagement was not that great, and because the calcium carbonate loading was very low. Typically, it is thought that the filler loading should be 35% or greater in order to create enough microporosity in the film to have an acceptable WVTR value.

Tensile Test

This method was used to determine the force versus engineering strain curve of the materials. The tensile test method is based on ASTM D882-02. Suitable instruments for this test include tensile testers available from MTS Systems Corp. (Eden Prairie, Minn.) or Instron Engineering Corp. (Canton, Mass.). For the test, test specimens of each material with dimensions of 25.4 mm wide by about 100 mm long were cut. The samples were conditioned for at least 1 hour at 23°±2° C. Each specimen was then mounted with the long axis substantially vertical in 1.00 inch wide grips, with a gap of 2.00 inches between the grip faces and no slack in the specimen. The specimen is then stretched by the testing machine at a crosshead speed of 20 inches per minute (50.8 cm/min) until the sample breaks. A minimum of three specimens are used to determine average test values.

The tensile test results are reported for each material as percent strain at break. The percent strain at break measures how long the laminate can stretch before it breaks. The ultimate tensile strength measures how much force must be exerted on the sample immediately before it breaks.

WVTR Test

This method is used to determine the water vapor transmission rate (WVTR) of the materials. The WVTR test method is based on ASTM D6701-01, “Standard Test Method for Determining Water Vapor Transmission Rates Through Nonwoven and Plastic Barriers.” Suitable instruments for this test include MOCON PERMATRAN-W 101K from MOCON, Inc. (Minneapolis, Minn.). The instrument test cell has a dry chamber separated by a permanent guard film from a wet chamber of known temperature and humidity. For the test, test specimens of each material with circular area of 10 cm² are cut. Each specimen is then mounted next to the guard film in the holder of the test cell. If testing a laminated material, the better barrier side (e.g. the film side) is mounted toward the carrier gas side of the test cell and the poorer barrier side (e.g. the nonwoven side) toward the guard film. Water vapor diffuses from the wet chamber into the dry chamber through the guard film and test specimen. Nitrogen is introduced into the dry chamber of the test cell to collect the diffused water vapor. The concentration of diffused water vapor is detected, and this value is used to calculate the water vapor transmission rate through the sample specimen. Each test is conducted for 5 minutes under controlled temperature of 37.8° C. and relative humidity of 90%. A minimum of three specimens are used to determine average test values. The WVTR results are reported for each material as grams/square meter/24 hours.

The Examples and specific embodiments described herein are for illustrative purposes only and are not intended to be limiting of the invention defined by the following claims. Additional embodiments and examples within the scope of the claimed invention will be apparent to one of ordinary skill in the art.

This has been a description of the present invention. However, the invention itself should only be defined by the appended claims.

We claim:

1. A polymer film, comprising a thermoplastic polymer made from a petroleum-based source and a biodegradable or sustainable (Bio-Sus) polymer, wherein the Bio-Sus polymer comprises about 5-30% of said film's polymer composition.

2. The film according to claim 1, wherein the Bio-Sus polymer comprises about 5-25% of said film's polymer composition.

3. The film according to claim 1, wherein the Bio-Sus polymer is made from a sustainable source.

4. The film according to claim 3, wherein the Bio-Sus polymer is made from a plant-based source.

5. The film according to claim 3, wherein the Bio-Sus polymer is made from a bacterial or microbial source.

6. The film according to claim 1, wherein the Bio-Sus polymer is selected from the group consisting of polymers comprising aliphatic polyesters, thermoplastic starch, biodegradable polyesters, sustainable thermoplastic starch blends, copolymers thereof, and blends thereof.

7. The film according to claim 6, wherein the Bio-Sus polymer is selected from the group consisting of polymers comprising polylactic acid, polycaprolactone, polyhydroxy alkanoates, polyhydroxybutyrates, polyhydroxyvalerates, copolymers thereof, and blends thereof.

8. The film according to claim 1, wherein the Bio-Sus polymer is a polyolefin made from a source that is not petroleum-based.

9. The film according to claim 1, wherein the film has a tensile strain at break of greater than about 50% in the cross direction.

10. The film according to claim 9, wherein the film has a tensile strain at break of greater than about 70% in the cross direction.

11. The film according to claim 9, wherein the film has a tensile strain at break of greater than about 100% in the cross direction.

12. The film according to claim 1, wherein the petroleum-based polymer is selected from the group consisting of polyolefins, polyesters, polyamides, poly(ether amides), polyurethanes, copolymers thereof, and blends thereof.

13. The film according to claim 12, wherein the petroleum-based polymer is selected from the group consisting of ultra-low-density polyethylene, low-density polyethylene, linear low-density polyethylene, medium density polyethylene, high density polyethylene, copolymers of ethylene with other alpha-olefins, isotactic polypropylene, syndiotactic polypropylene, copolymers thereof and blends thereof.

14. The film according to claim 1, wherein the film also comprises a compatibilizing polymer.

15. The film according to claim 14, wherein the compatibilizing polymer is selected from the group consisting of polyesters, poly(alkyl methyl acrylates), poly(alkyl acrylates), polyvinyl acetate, polystyrene, copolymers thereof and blends thereof.

16. The film according to claim 14, wherein the compatibilizing polymer comprises poly(ethyl methyl acrylate).

17. The film according to claim 14, wherein the compatibilizing polymer comprises about 5-20% of the film's polymer composition.

18. The film according to claim 1, wherein the film also comprises a filler.

19. The film according to claim 18, wherein the film is microporous and breathable.

20. The film according to claim 18, wherein the filler comprises about 25-75% of the film's composition.

21. The film according to claim 18, wherein the filler comprises about 30-55% of the film's composition.

22. The film according to claim 18, wherein the filler is selected from the group consisting of metal oxides, metal hydroxides, metal carbonates, silicates, organic polymers, and mixtures thereof.

23. The film according to claim 18, wherein the filler is selected from the group consisting of calcium carbonate, barium sulfate, diatomaceous earth, talc, silica dioxide, and mixtures thereof.

24. The film according to claim 18, wherein the filler is a calcium carbonate selected from the group consisting of mined calcium carbonate, precipitated calcium carbonate, sustainable calcium carbonate, and mixtures thereof.

25. The film according to claim 1, wherein the film is laminated to another substrate layer.

26. The film according to claim 25, wherein said substrate layer is a nonwoven fabric.

27. The film according to claim 25, wherein the film is laminated to said substrate layer by extrusion lamination, adhesive lamination, ultrasonic lamination, thermal lamination, calender lamination, or combinations thereof.

28. The film according to claim 1, wherein the film basis weight is between about 5 and 150 gsm.

29. The film according to claim 1, wherein the film basis weight is between about 10 and 40 gsm.

30. A method of making a polymer film, comprising forming a film comprising a thermoplastic polymer made from a petroleum-based source and a biodegradable or sustainable (Bio-Sus) polymer, wherein the Bio-Sus polymer comprises about 5-30% of said film's polymer composition.

31. A method of making a film according to claim 30, wherein the film is formed by cast extrusion or blown extrusion.

32. A method of making a film according to claim 30, wherein the film also comprises a filler.

33. A method of making a film according to claim 32, wherein the film is rendered microporous by activating the film.

34. A method of making a film according to claim 33, wherein the film is activated by machine-direction orientation, tentering, incremental stretching, or combinations thereof.

35. A method of making a film laminate, comprising:
a) forming a film comprising a thermoplastic polymer made from a petroleum-based source and a biodegradable or sustainable (Bio-Sus) polymer, wherein the Bio-Sus polymer comprises about 5-30% of said film's polymer composition; and
b) bonding said film to another substrate layer to form a laminate.

36. A method of making a laminate according to claim 35, wherein said bonding comprises extrusion lamination, adhesive lamination, ultrasonic lamination, thermal lamination, calender lamination, or combinations thereof.

37. A method of making a film laminate according to claim 35, wherein the film layer also comprises a filler.

38. A method of making a film laminate according to claim 35, comprising the additional step of activating said laminate.

39. A method of making a film laminate according to claim 38, wherein said activation step comprises machine-direction orientation, tentering, incremental stretching, or combinations thereof.

40. A method of making a film laminate according to claim 37, comprising the additional step of activating said laminate to render the film layer microporous.

41. A method of making a film laminate according to claim 40, wherein said activation step comprises machine-direction orientation, tentering, incremental stretching, or combinations thereof.

42. A polymer film, comprising a polyolefin polymer made from a sustainable source and a biodegradable or sustainable (Bio-Sus) polymer, wherein the Bio-Sus polymer comprises about 5-30% of said film's polymer composition.

43. The film according to claim 42, wherein the Bio-Sus polymer is selected from the group consisting of polymers comprising aliphatic polyesters, thermoplastic starch, biodegradable polyesters, sustainable thermoplastic starch blends, copolymers thereof, and blends thereof.

44. The film according to claim 42, wherein the Bio-Sus polymer is an aliphatic polyester.

45. The film according to claim 42, wherein the film also comprises a filler.

46. The film according to claim 45, wherein the film is microporous and breathable.

47. The film according to claim 42, wherein the film is laminated to another substrate layer.

48. The film according to claim 42, wherein the film basis weight is between about 5 and 150 gsm.

49. The film according to claim 40, wherein the film basis weight is between about 10 and 40 gsm.

50. A method of making a polymer film according to claim 40, comprising forming a film comprising a polyolefin polymer made from a sustainable source and a Bio-Sus polymer, wherein the Bio-Sus polymer comprises about 5-30% of said film's polymer composition.
